(19) United States
(12) Patent Application Publication
(10) Pub. No.: US 2023/0206776 A1
(43) Pub. Date: Jun. 29, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventors: Yasushi SANO, Kanagawa (JP); Satoru KUWA, Kanagawa (JP); Koichi HOMMA, Kanagawa (JP)

(73) Assignee: FUJIFILM Business Innovation Corp., Tokyo (JP)

(21) Appl. No.: 17/723,471

(22) Filed: Apr. 19, 2022

(30) Foreign Application Priority Data
Dec. 27, 2021 (JP) 2021-213453

(51) Int. Cl. G09B 7/04

(52) U.S. Cl. CPC G09B 7/04

(57) ABSTRACT

An information processing apparatus includes a processor configured to: acquire a recognition result being a result of recognizing an answer sheet in which an answer to a question has been scored, by a recognition process; and present teaching material information being information regarding a teaching material, from teaching materials stored in advance in accordance with the acquired recognition result.

### CROSS-REFERENCE TO RELATED APPLICATIONS

This application is based on and claims priority under 35 USC 119 from Japanese Patent Application No. 2021-213453 filed Dec. 27, 2021.

### BACKGROUND

### (I) Technical Field

The present invention relates to an information processing apparatus, a non-transitory computer readable medium storing an information processing program, and an information processing method.

### (II) Related Art

JP4977723B discloses a learning support server connected to a Web server for an e-learning system that provides teaching material information and test questions to a plurality of student terminals via a communication network. The learning support server includes an answer history information file in which student answer information received from the Web server is stored as answer history information of each student, a question information file indicating a relation between an identifier of each test question and a plurality of teaching material identifiers for a plurality of test questions, an answer analysis information file that is associated with identifiers of the plurality of test questions and indicates a relation with the plurality of teaching material identifiers for each answer, and a teaching-material determination information file in which, for a plurality of teaching materials specified by the teaching material identifiers, a determination parameter value in a case where the test question is selected as the next proposed teaching material is stored for each identifier of the test question. The learning support server updates the answer analysis information file based on the answer history information file and the question information file, and updates the teaching-material determination information file based on the answer history information file and the answer analysis information file. The learning support server selects a next proposed teaching material to be proposed to a student of the student answer information, based on the teaching-material determination information file and notifies the Web server of the selected teaching material.

### SUMMARY

There is a system that aggregates the scoring results of the answers of a plurality of students and presents the tendency of questions that students are likely to make mistakes to the teacher. The teacher may recognize the tendency of the question that is easy to make a mistake by presenting the system, select the teaching material appropriate for each student according to the tendency, and present the teaching material to each student.

Aspects of non-limiting embodiments of the present disclosure relate to an information processing apparatus, a non-transitory computer readable medium storing an information processing program, and an information processing method capable of reducing a burden of selection by a teacher in comparison to a case where the teacher presents a teaching material appropriate for each student in consideration of the tendency of a question.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire a recognition result being a result of recognizing an answer sheet in which an answer to a question has been scored, by a recognition process; and present teaching material information being information regarding a teaching material, from teaching materials stored in advance in accordance with the acquired recognition result.

### BRIEF DESCRIPTION OF THE DRAWINGS

Exemplary embodiment(s) of the present invention will be described in detail based on the following figures, wherein:

FIG. 1 is a schematic diagram illustrating an example of a configuration of an information processing system according to an exemplary embodiment;

FIG. 2 is an activity diagram illustrating an example of a series of flows from creation of a test to presentation of a teaching material according to the exemplary embodiment;

FIG. 3 is a block diagram illustrating an example of a hardware configuration of an information processing apparatus according to the exemplary embodiment;

FIG. 4 is a block diagram illustrating an example of a functional configuration of the information processing apparatus according to the exemplary embodiment;

FIG. 5 is a diagram illustrating an example of image data of an answer sheet according to the exemplary embodiment; and

FIG. 6 is a flowchart illustrating an example of a process of presenting a teaching material according to the exemplary embodiment.

### DETAILED DESCRIPTION

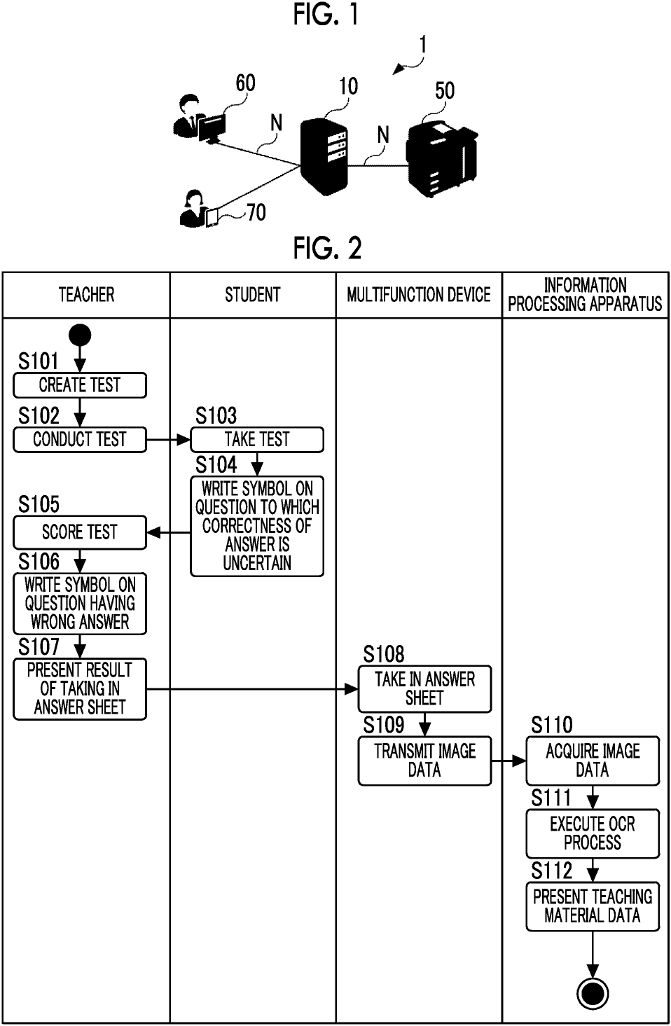

Hereinafter, embodiments for carrying out the present invention will be described in detail with reference to the drawings. FIG. 1 is a schematic diagram illustrating an example of a configuration of an information processing system 1 according to an exemplary embodiment.

As an example, as illustrated in FIG. 1, the information processing system 1 is configured to include an information processing apparatus 10 which is a server, a multifunction device 50 equipped with a scanner function, a teacher terminal 60 operated by a teacher, and a student terminal 70 operated by a student. The information processing apparatus 10, the multifunction device 50, the teacher terminal 60, and the student terminal 70 are connected to each other via a network N. In the exemplary embodiment, the information processing apparatus 10 will be described as a server. However, the present disclosure is not limited to this. The information processing apparatus 10 may be mounted in the multifunction device 50, or may be mounted in the teacher terminal 60 and the student terminal 70.

The information processing apparatus 10 uses image data taken by scanning an answer sheet made by answers of a student as image data and presents information (referred to as “teaching material data” below) regarding a teaching material corresponding to the image data to the student terminal 70. For example, the information processing apparatus 10 selects a teaching material including an explanation and the like for a question in which a student made a mistake and a question to which correctness of an answer is uncertain, from the image data. Then, the information processing apparatus 10 stores the selected teaching material in a folder and transmits a storage location in which the teaching material is stored, to the student terminal 70.

The multifunction device 50 takes an answer sheet having answers of a student as image data and transmits the answer sheet to the information processing apparatus 10.

The teacher terminal 60 and the student terminal 70 are terminals such as personal computers, tablets, and portable terminals. The teacher terminal 60 and the student terminal 70 acquire data (referred to as “teaching material data” below) about a teaching material, from the information processing apparatus 10.

A form in which the answer sheet according to the exemplary embodiment is taken as image data by the multifunction device 50 will be described. However, the present disclosure is not limited to this. The image data may be obtained by capturing of a camera (not illustrated). For example, the answer sheet may be captured as image data by a camera (not illustrated) mounted on the teacher terminal 60 or the student terminal 70, and such image data may be transmitted to the information processing apparatus 10. The teaching material data according to the exemplary embodiment refers to information regarding a material in which an explanation for a question is described, a material in which the main points of a unit (for example, “Kamakura period” and “quadratic function”) related to a question, or a reference book containing the unit related to a question.

Next, a series of flows from creation of a test by a teacher until the information processing apparatus 10 presents teaching material data will be described with reference to FIG. 2. FIG. 2 is an activity diagram illustrating an example of the flow from the creation of a test to the presentation of teaching material data.

As an example, as illustrated in FIG. 2, a teacher prepares a test (Step S101) and conducts the test on a student to cause the student to answer a question in the prepared test (Step S102).

The student takes the test and writes an answer to a question in the test, in an answer sheet (Step S103). The student writes a predetermined specific symbol (for example, star) on a question to which an answer is unknown and a question to which correctness of an answer is uncertain, for example, whether the answer sheet is a correct answer, in the answer sheet (Step S104). The predetermined specific symbol is referred to as a “specific symbol” below.

The teacher scores the test taken by the student (Step S105). The teacher writes a specific symbol (for example, star) on a question having a wrong answer in the scored answer sheet (Step S106). The teacher instructs the multifunction device 50 to take in the answer sheet, and takes in the answer sheet on which a specific symbol is written (Step S107).

The multifunction device 50 takes in the answer sheet as image data (Step S108) and transmits the obtained image data to the information processing apparatus 10 (Step S109).

The information processing apparatus 10 acquires image data from the multifunction device 50 (Step S110). The information processing apparatus 10 executes an optical character recognition (OCR) process on the acquired image data to extract a symbol (Step S111), and presents teaching material data for the question to which the symbol is written (Step S112). Here, the OCR process is an example of a “recognition process”.

As described above, the information processing apparatus 10 is capable of extracting a question to which correctness of an answer is uncertain and a question having a wrong answer, and presenting teaching material data for the extracted question.

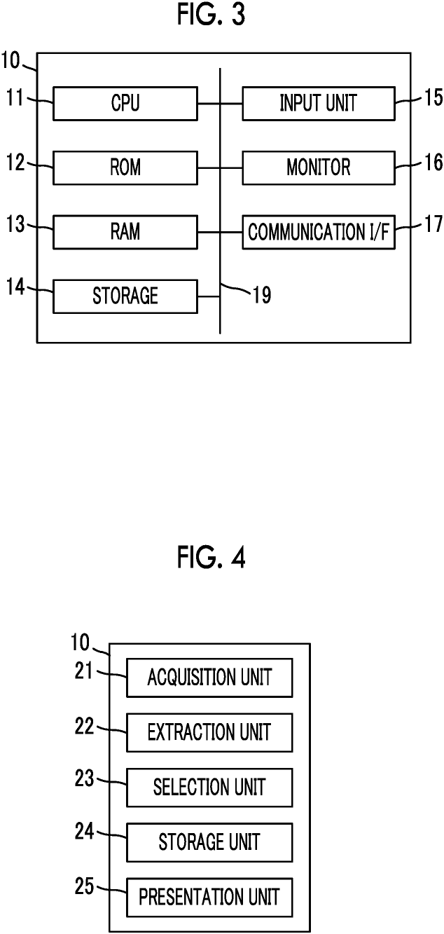

Next, a hardware configuration of the information processing apparatus 10 will be described below with reference to FIG. 3. FIG. 3 is a block diagram illustrating an example of the hardware configuration of the information processing apparatus 10 according to the exemplary embodiment.

As illustrated in FIG. 3, the information processing apparatus 10 according to the exemplary embodiment is configured to include a central processing unit (CPU) 11, a read only memory (ROM) 12, a random access memory (RAM) 13, a storage 14, an input unit 15, a monitor 16, and a communication interface (communication I/F) 17. The CPU 11, the ROM 12, the RAM 13, the storage 14, the input unit 15, the monitor 16, and the communication I/F 17 are connected to each other by a bus 19. Here, the CPU 11 is an example of a processor.

The CPU 11 collectively controls the entirety of the information processing apparatus 10. The ROM 12 stores various programs, data, and the like including an information processing program used in the exemplary embodiment. The RAM 13 is a memory used as a work area in execution of various programs. The CPU 11 expands the program stored in the ROM 12 into the RAM 13 and executes the program to execute a process of presenting the teaching material data.

The storage 14 is a hard disk drive (HDD), a solid state drive (SSD), or a flash memory as an example. The storage 14 according to the exemplary embodiment includes a question information DB (database) that stores question information in which a question number and a question sentence are associated with each other. The storage 14 further includes a teaching material information DB that stores teaching material data in which the main points and explanations for each subject and each unit are described, and teaching material data being a material in which an explanation for each question is described. The storage 14 further includes a student information DB that stores student information in which the name of a student and a contact point such as an e-mail address of a student terminal 70 are associated with each other. The storage 14 may store the information processing program and the like.

The input unit 15 is a touch panel, a keyboard, or the like that receives an input of a text or the like. The monitor 16 displays texts and images. The communication I/F 17 transmits/receives data.

Next, a functional configuration of the information processing apparatus 10 will be described with reference to FIG. 4. FIG. 4 is a block diagram illustrating an example of the functional configuration of the information processing apparatus 10 according to the exemplary embodiment.

As an example, as illustrated in FIG. 4, the information processing apparatus 10 includes an acquisition unit 21, an extraction unit 22, a selection unit 23, a storage unit 24, and a presentation unit 25. The CPU 11 executes the information processing program to function as the acquisition unit 21, the extraction unit 22, the selection unit 23, the storage unit 24, and the presentation unit 25.

The acquisition unit 21 acquires image data from the multifunction device 50. Here, the acquired image data is image data obtained by taking in an answer sheet on which a specific symbol is written by a student or a teacher.

The extraction unit 22 extracts a specific symbol, a text string (referred to as a “subject text string” below) indicating a subject related to a question, and a text string (referred to as a “name text string” below) indicating the name of a student who answered the question, from the acquired image data by the OCR process. In a case where the extraction unit 22 extracts the specific symbol, the extraction unit 22 extracts a question number for identifying a question written in a predetermined direction (for example, on the left side and on the upper side) with such a symbol as a base point. Then, the extraction unit 22 specifies a question sentence by using the extracted question number. Here, the question number is an example of an “identifier”.

In a case where the answer sheet contains a question sentence, the extraction unit 22 extracts the question number from the image data related to the answer sheet, and specifies a question sentence written in a predetermined direction (for example, on the right side and on the lower side) with the extracted question number as a base point. The extraction unit 22 extracts a word (referred to as a “characteristic word” below) indicating the characteristics of the question from the specified question sentence. In a case where the answer sheet does not contain a question sentence, the extraction unit 22 specifies a question sentence corresponding to the extracted question number among question sentences stored in the question information DB, and extracts a characteristic word indicating the characteristics of the question from the specified question sentence.

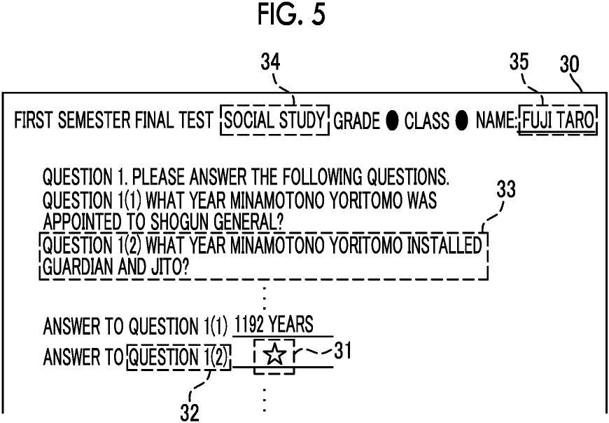

For example, the extraction unit 22 extracts a specific symbol 31 from image data 30 related to an answer sheet illustrated in FIG. 5 as an example, and extracts a question number 32 described on the left side of the specific symbol 31.

In a case where the image data 30 related to the answer sheet contains a question sentence 33, the extraction unit 22 specifies the question sentence 33 contained in the image data 30 by using the extracted question number 32, and extracts a plurality of characteristic words such as “Minamotono Yoritomo”, “guardian”, and “jito” from the question sentence 33. In a case where the image data 30 related to the answer sheet does not contain the question sentence 33, the extraction unit 22 specifies a question sentence corresponding to the extracted question number 32, from the question information DB, and extracts a characteristic word indicating the characteristics of the question from the question sentence.

As illustrated in FIG. 5, the extraction unit 22 extracts a subject text string 34 indicating a subject related to the question and a name text string 35 indicating the name of a student who answered the question, from the image data 30.

The selection unit 23 selects teaching material data by using the characteristic word extracted by the extraction unit 22. Specifically, the selection unit 23 selects teaching material data corresponding to the characteristic word, from the teaching material information DB. Here, in a case where there are a plurality of pieces of teaching material data corresponding to the characteristic word, the selection unit 23 selects teaching material data having a high matching rate (including the most of the plurality of characteristic words) with the characteristic word including a plurality of words among the plurality of pieces of teaching material data.

The selection unit 23 according to the exemplary embodiment has described a form of selecting teaching material data by using a characteristic word. However, the present disclosure is not limited to this. In a case where the selection unit 23 selects teaching material data, the selection unit 23 may select the teaching material data by using the subject text string 34. For example, the selection unit 23 selects a subject corresponding to the subject text string 34 from the teaching material data classified by the subject, and selects the teaching material data corresponding to the characteristic word from the selected subject-specific teaching material data.

The storage unit 24 stores the selected teaching material data. Specifically, the storage unit 24 creates a folder (directory) in the storage 14 to store information related to materials selected as teaching material data, reference books, and the like. In the exemplary embodiment, a form of storing the selected teaching material data in the storage 14 of the information processing apparatus 10 has been described. However, the present disclosure is not limited to this. The storage unit 24 may store teaching material data selected in an external storage device (cloud) or the like.

The presentation unit 25 searches a contact point corresponding to the name text string 35 extracted by the extraction unit 22, from the student information DB, and performs presentation by notifying the searched contact point of a location of a folder in which teaching material data is stored. In the exemplary embodiment, a form of performing a notification of the location of the folder in which the teaching material data is stored has been described. However, the present disclosure is not limited to this. The presentation unit 25 may transmit the teaching material data to the student terminal 70. In the exemplary embodiment, a form of notifying the student terminal 70 of the location of the folder has been described. However, the present disclosure is not limited to this. The presentation unit 25 may notify the teacher terminal 60 of the location of the folder.

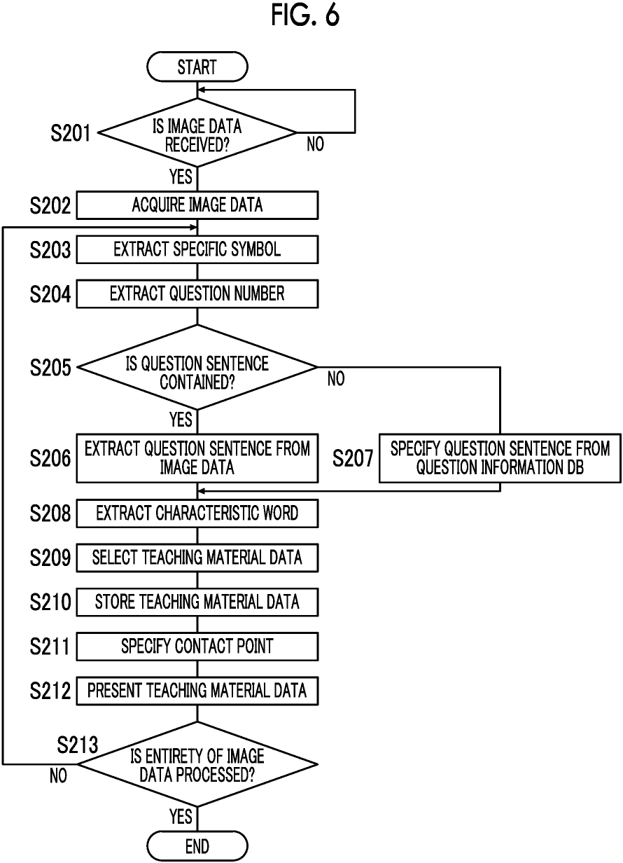

Next, an operation of the information processing apparatus 10 according to the exemplary embodiment will be described with reference to FIG. 6. FIG. 6 is a flowchart illustrating an example of a process of presenting teaching material data according to the exemplary embodiment. The information processing illustrated in FIG. 6 is executed by the CPU 11 reading out the information processing program from the ROM 12 or the storage 14 and executing the information processing program. The information processing illustrated in FIG. 6 is executed, for example, in a case where an instruction to execute a process of performing presentation is input.

In Step S201, the CPU 11 determines whether or not image data taking in an answer sheet is received from the multifunction device 50. In a case where the image data is received (Step S201: YES), the CPU 11 proceeds to Step S202. In a case where the image data is not received (Step S201: NO), the CPU 11 waits until the image data is received from the multifunction device 50.

In Step S202, the CPU 11 acquires the received image data 30.

In Step S203, the CPU 11 extracts a specific symbol 31 from the image data 30. Here, the CPU 11 extracts a subject text string 34 and a name text string 35 from the answer sheet contained in the image data 30 together with the specific symbol 31.

In Step S204, the CPU 11 extracts a question number 32 located in a predetermined direction with the extracted specific symbol 31 as a base point.

In Step S205, the CPU 11 determines whether or not the image data 30 contains a question sentence 33. In a case where the image data 30 contains the question sentence 33 (Step S205: YES), the CPU 11 proceeds to Step S206. In a case where the image data 30 does not contain the question sentence 33 (Step S205: NO), the CPU 11 proceeds to Step S207.

In Step S206, the CPU 11 extracts the question sentence 33 corresponding to a question number 32 extracted from the image data 30.

In Step S207, the CPU 11 specifies the question sentence 33 corresponding to the question number 32 extracted from the question information DB.

In Step S208, the CPU 11 extracts a characteristic word indicating the characteristics of the question from the question sentence 33.

In Step S209, the CPU 11 selects teaching material data from the teaching material information DB by using the extracted characteristic word. Here, the CPU 11 specifies the subject-specific teaching material data corresponding to the subject text string 34, and selects the teaching material data corresponding to the extracted characteristic word.

In Step S210, the CPU 11 creates a folder in the storage 14 and stores the selected teaching material data in the created folder.

In Step S211, the CPU 11 specifies the contact point corresponding to the name text string 35 extracted from the student information DB.

In Step S212, the CPU 11 presents the teaching material data by notifying the specified contact point of a storage location of the teaching material data.

In Step S213, the CPU 11 determines whether or not all answer sheet contained in the image data 30 have been processed. In a case where all the answer sheets have been processed (Step S213: YES), the CPU 11 ends the process of presenting the teaching material data. In a case where not all the answer sheets is processed (there is an unprocessed answer sheet) (Step S213: NO), the CPU 11 proceeds to Step S203 and extracts a specific symbol 31 from the unprocessed answer sheet.

As described above, according to the exemplary embodiment, it is possible to reduce the burden of selection by the teacher in comparison to a case where the teacher presents a teaching material appropriate for each student in consideration of the tendency of a question.

### Modification Examples

In the exemplary embodiment, a form in which the teacher and the student write the identical specific symbol 31 on the answer sheet has been described. However, the present disclosure is not limited to this. The teacher and each student may write different specific symbols 31 on the answer sheet. For example, the teacher writes a cross mark on a question having a wrong answer, and the student writes a star mark on a question to which correctness of an answer is uncertain.

In a case where different specific symbols 31 are written on the answer sheet, the extraction unit 22 in the information processing apparatus 10 extracts each of the specific symbols 31, and the presentation unit 25 presents teaching material data corresponding to each of the specific symbols 31. That is, the information processing apparatus 10 presents, as teaching material data, a material in which explanations for reaching the correct answer are described, from the teaching material information DB, for a question in which the answer is incorrect and the cross mark is written. In addition, the information processing apparatus 10 presents, as teaching material data, a material in which more detailed explanations and the main points to be remembered are described, from the teaching material information DB, for a question to which correctness of an answer is uncertain and on which a star mark is written.

As described above, according to the present modification example, it is possible to distinguish the specific symbols 31 from each other, and to present teaching material data in accordance with the purpose in which each specific symbol 31 is written.

Further, in the exemplary embodiment, a form of extracting the question number 32 located in the predetermined direction with the specific symbol 31 written on the answer sheet contained in the image data 30 as a base point has been described. However, the present disclosure is not limited to this. The direction for extracting the question number 32 may be set in advance by a user, or the information processing apparatus 10 may receive the direction for extracting the question number 32 from the user.

In the exemplary embodiment, a form in which, in a case where the answer sheet contains the question sentence 33, the question sentence 33 located in the predetermined direction with the extracted question number 32 as a base point is extracted has been described. However, the present disclosure is not limited to this. The direction for extracting the question sentence 33 may be set in advance by a user, or the information processing apparatus 10 may receive the direction for extracting the question number 32 from the user.

Further, in the exemplary embodiment, a form of extracting the question number 32 from the answer sheet contained in the image data 30 and specifying the question sentence 33 has been described. However, the present disclosure is not limited to this. For example, in a case where the answer sheet is provided with columns for writing an answer around the question sentence 33, for example, on the lower side and the right side of the question sentence 33, the question sentence 33 may be extracted without extracting the question number 32. Specifically, in a case where a column for writing an answer is provided around the question sentence 33, for example, on the lower side and the right side of the question sentence 33, and a specific symbol 31 is written in the column for writing the answer, the question sentence 33 located in the predetermined direction (on the upper side, on the left side, and the like) with the specific symbol 31 as a base point may be extracted.

Further, in the exemplary embodiment, a form in which, in a case where the answer sheet contained in the image data 30 does not contain the question sentence 33, the question sentence 33 is specified from the question information DB has been described. However, the present disclosure is not limited to this. For example, in a case where it is not possible to extract the question sentence 33 corresponding to the extracted question number 32 from the image data 30, the question sentence 33 corresponding to the question number 32 may be specified from the question information DB.

Hitherto, the present invention has been described above by using the exemplary embodiment, but the present invention is not limited to the scope described in the exemplary embodiment. Various changes and improvements can be added to the exemplary embodiment without departing from the scope of the present invention, and exemplary embodiments to which the changes or improvements are added are also included in the technical scope of the present invention.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiment, a form in which the information processing program is installed in the storage has been described, but the present disclosure is not limited to this. The information processing program according to the exemplary embodiment may be provided in a form of being recorded on a computer-readable storage medium. For example, the information processing program according to the exemplary embodiment may be provided in a form of being recorded on an optical disk such as a compact disc (CD)-ROM and a digital versatile disc (DVD)-ROM. The information processing program according to the exemplary embodiment may be provided in a form of being recorded in a semiconductor memory such as a universal serial bus (USB) memory and a memory card. Further, the information processing program according to the exemplary embodiment may be acquired from an external device via a communication line connected to the communication I/F.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire a recognition result being a result of recognizing an answer sheet in which an answer to a question has been scored, by a recognition process; and
present teaching material information being information regarding a teaching material, from teaching materials stored in advance in accordance with the acquired recognition result.

2. The information processing apparatus according to claim 1, wherein the processor is further configured to:
present the teaching material information related to a question to which a specific symbol is attached in the recognition result.

3. The information processing apparatus according to claim 2, wherein the processor is further configured to:
select and present the teaching material information corresponding to a word contained in a question sentence related to the question to which the symbol is attached.

4. The information processing apparatus according to claim 3, wherein the processor is further configured to:
in a case where the answer sheet contains a question sentence, extract the word from a question sentence located in a predetermined direction with the symbol as a base point.

5. The information processing apparatus according to claim 3, wherein the processor is further configured to:
in a case where the answer sheet does not contain a question sentence, extract an identifier for identifying the question located in a predetermined direction with the symbol as a base point, and
present the teaching material information related to the question indicated by the identifier.

6. The information processing apparatus according to claim 4, wherein the processor is further configured to:
in a case where the answer sheet does not contain a question sentence, extract an identifier for identifying the question located in a predetermined direction with the symbol as a base point, and
present the teaching material information related to the question indicated by the identifier.

7. The information processing apparatus according to claim 2,
wherein the symbol indicates at least one of a question having a wrong answer or a question to which correctness of an answer is uncertain.

8. The information processing apparatus according to claim 3,
wherein the symbol indicates at least one of a question having a wrong answer or a question to which correctness of an answer is uncertain.

9. The information processing apparatus according to claim 4,
wherein the symbol indicates at least one of a question having a wrong answer or a question to which correctness of an answer is uncertain.

10. The information processing apparatus according to claim 5,
wherein the symbol indicates at least one of a question having a wrong answer or a question to which correctness of an answer is uncertain.

11. The information processing apparatus according to claim 6,
wherein the symbol indicates at least one of a question having a wrong answer or a question to which correctness of an answer is uncertain.

12. The information processing apparatus according to claim 7, wherein the processor is further configured to:
in a case where each of a symbol indicating a question having a wrong answer and a symbol indicating a question to which correctness of an answer is uncertain is attached in the recognition result, present each piece of teaching material information related to the question having a wrong answer and teaching material information related to the question to which the correctness of the answer is uncertain.

13. The information processing apparatus according to claim 8, wherein the processor is further configured to:
in a case where each of a symbol indicating a question having a wrong answer and a symbol indicating a question to which correctness of an answer is uncertain is attached in the recognition result, present each piece of teaching material information related to the question having a wrong answer and teaching material information related to the question to which the correctness of the answer is uncertain.

14. The information processing apparatus according to claim 9, wherein the processor is further configured to:
in a case where each of a symbol indicating a question having a wrong answer and a symbol indicating a question to which correctness of an answer is uncertain is attached in the recognition result, present each piece of teaching material information related to the question having a wrong answer and teaching material information related to the question to which the correctness of the answer is uncertain.

15. The information processing apparatus according to claim 10, wherein the processor is further configured to:
in a case where each of a symbol indicating a question having a wrong answer and a symbol indicating a question to which correctness of an answer is uncertain is attached in the recognition result, present each piece of teaching material information related to the question having a wrong answer and teaching material information related to the question to which the correctness of the answer is uncertain.

16. The information processing apparatus according to claim 11, wherein the processor is further configured to:
in a case where each of a symbol indicating a question having a wrong answer and a symbol indicating a question to which correctness of an answer is uncertain is attached in the recognition result, present each piece of teaching material information related to the question having a wrong answer and teaching material information related to the question to which the correctness of the answer is uncertain.

17. The information processing apparatus according to claim 1, wherein the processor is further configured to:
further extract a word indicating a subject contained in the answer sheet from the recognition result, and
select and present the teaching material information corresponding to the word.

18. The information processing apparatus according to claim 2, wherein the processor is further configured to:
further extract a word indicating a subject contained in the answer sheet from the recognition result, and
select and present the teaching material information corresponding to the word.

19. A non-transitory computer readable medium storing an information processing program causing a computer to execute a process comprising:
acquiring a recognition result being a result of recognizing an answer sheet in which an answer to a question has been scored, by a recognition process; and
presenting teaching material information being information regarding a teaching material, from teaching materials stored in advance in accordance with the acquired recognition result.

20. An information processing method comprising:
acquiring a recognition result being a result of recognizing an answer sheet in which an answer to a question has been scored, by a recognition process; and
presenting teaching material information being information regarding a teaching material, from teaching materials stored in advance in accordance with the acquired recognition result.
